(19) United States
(12) Patent Application Publication
(10) Pub. No.: US 2025/0181985 A1
(43) Pub. Date: Jun. 5, 2025

(54) LCS ARCHITECTURE ENHANCEMENTS FOR AI/ML-BASED POSITIONING

(71) Applicants: Debdeep Chatterjee, San Jose, CA (US); Meghashree Dattatri Kedalagudde, Hillsboro, OR (US); Ziyi Li, Beijing (CN); Alexandre Saso Stojanovski, Paris (FR)

(72) Inventors: Debdeep Chatterjee, San Jose, CA (US); Meghashree Dattatri Kedalagudde, Hillsboro, OR (US); Ziyi Li, Beijing (CN); Alexandre Saso Stojanovski, Paris (FR)

(21) Appl. No.: 19/050,386

(22) Filed: Feb. 11, 2025

Related U.S. Application Data
(60) Provisional application No. 63/554,059, filed on Feb. 15, 2024.

(51) Int. Cl. G06N 20/00; H04W 4/02; H04W 24/08; H04W 64/00

(52) U.S. Cl. CPC G06N 20/00; H04W 4/02; H04W 24/08; H04W 64/00

(57) ABSTRACT

Systems and methods are disclosed for supporting artificial intelligence/machine learning (AI/ML)-based positioning. A Network Data Analytics Function (NWDAF) containing a Model Training Logical Function (MTLF) for model training and containing Analytics Logic Function (AnLF) for inference and analytics derivation are provided. A Location Management Function (LMF) provides input data through positioning protocols, collecting measurements from a user equipment (UE) and next generation radio access network (NG-RAN) nodes. The LMF may provide inference capabilities rather than the AnLF, which performs analytics derivation using trained models provided by NWDAF MTLF.

### PRIORITY CLAIM

This application claims the benefit of priority under 35 U.S.C. 119(e) to U.S. Provisional Patent Application Ser. No. 63/554,059, filed Feb. 15, 2024, which is incorporated herein by reference in its entirety.

### TECHNICAL FIELD

Embodiments pertain to wireless networks and wireless communications. Some embodiments relate to artificial intelligence/machine language (AI/ML)-based user equipment (UE) positioning.

### BACKGROUND

Mobile communication has evolved significantly from early voice systems to highly sophisticated integrated communication platform. Next-generation (NG) wireless communication systems, including 5^{th} generation (5G) and sixth generation (6G) or new radio (NR) systems, are to provide access to information and sharing of data by various UEs and applications. NR is to be a unified network/system that is to meet vastly different and sometimes conflicting performance dimensions and services driven by different services and applications. As such, the complexity of such communication systems, as well as interactions between elements within a communication system, has increased. With the advent of next-generation wireless communication systems, there is an increasing demand for more sophisticated and efficient methods of data transmission and user positioning. Despite these advancements, existing methods for user positioning in wireless networks often rely on traditional techniques that may not fully leverage the potential of AI and ML technologies. These conventional approaches can be limited in terms of accuracy, efficiency, and adaptability to dynamic network conditions. As the demand for precise and real-time positioning grows, particularly in applications such as autonomous vehicles and internet of things (IoT) devices, it is desirable to enhance the capabilities of current systems including the development of new architectural enhancements that can support AI/ML-based positioning methods, offering improved performance and reliability in next-generation communication networks.

### BRIEF DESCRIPTION OF THE DRAWINGS

The present disclosure is illustrated by way of example and not limitation in the figures of the accompanying drawings, in which like references indicate similar elements and in which:

FIG. 1A illustrates an architecture of a network, in accordance with some aspects.

FIG. 1B illustrates a non-roaming 5G system architecture in accordance with some aspects.

FIG. 1C illustrates a non-roaming 5G system architecture in accordance with some aspects.

FIG. 2 illustrates a block diagram of a communication device in accordance with some embodiments.

FIG. 3 illustrates a system architecture in accordance with some aspects.

FIG. 4 illustrates a system architecture in accordance with some aspects.

FIG. 5 illustrates a model training procedure in accordance with some aspects.

### DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in or substituted for, those of other embodiments. Embodiments outlined in the claims encompass all available equivalents of those claims.

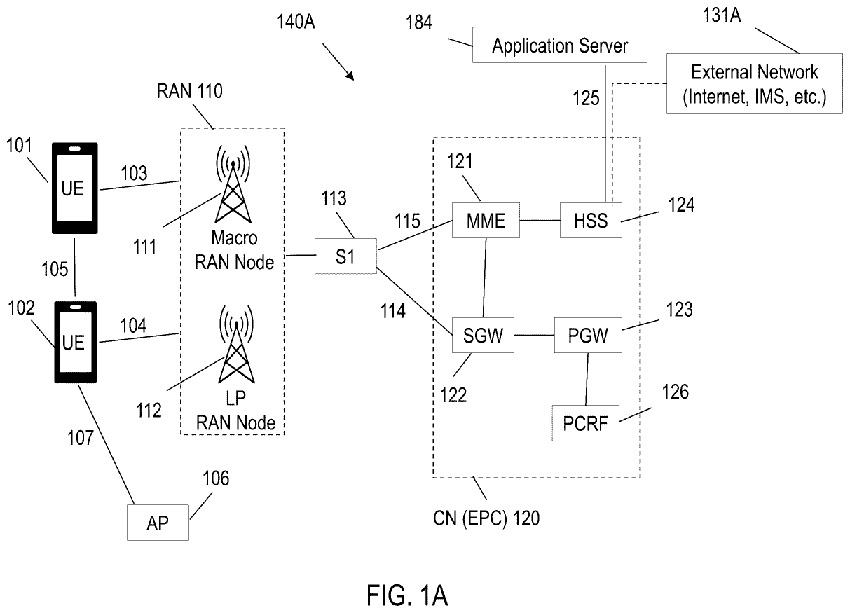

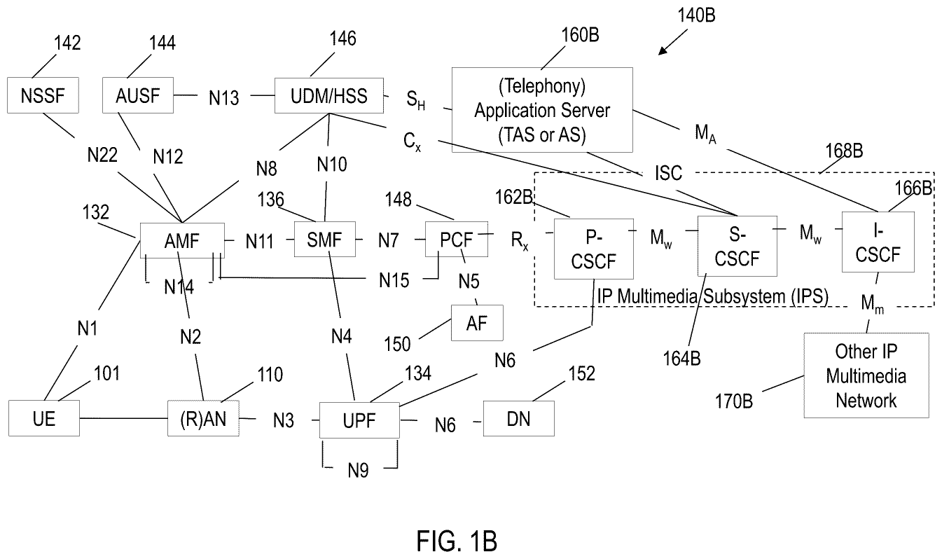

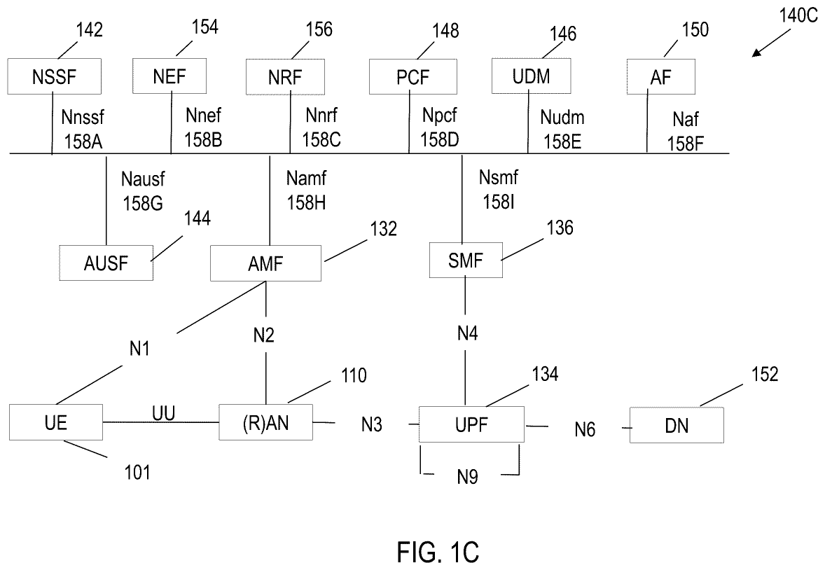

FIG. 1A illustrates an architecture of a network in accordance with some aspects. The network 140A includes 3GPP LTE/4G and NG network functions that may be extended to 6G functions. Accordingly, although 5G will be referred to, it is to be understood that this is to extend as able to 6G structures, systems, and functions. A network function may be implemented as a discrete network element on a dedicated hardware, as a software instance running on dedicated hardware, and/or as a virtualized function instantiated on an appropriate platform, e.g., dedicated hardware or a cloud infrastructure.

The network 140A is shown to include user equipment (UE) 101 and UE 102. The UEs 101 and 102 are illustrated as smartphones (e.g., handheld touchscreen mobile computing devices connectable to one or more cellular networks) but may also include any mobile or non-mobile computing device, such as portable (laptop) or desktop computers, wireless handsets, drones, or any other computing device including a wired and/or wireless communications interface. The UEs 101 and 102 may be collectively referred to herein as UE 101, and UE 101 may be used to perform one or more of the techniques disclosed herein.

Any of the radio links described herein (e.g., as used in the network 140A or any other illustrated network) may operate according to any exemplary radio communication technology and/or standard. Any spectrum management scheme including, for example, dedicated licensed spectrum, unlicensed spectrum, (licensed) shared spectrum (such as Licensed Shared Access (LSA) in 2.3-2.4 GHz, 3.4-3.6 GHz, 3.6-3.8 GHz, and other frequencies and Spectrum Access System (SAS) in 3.55-3.7 GHz and other frequencies). Different Single Carrier or Orthogonal Frequency Domain Multiplexing (OFDM) modes (CP-OFDM, SC-FDMA, SC-OFDM, filter bank-based multicarrier (FBMC), OFDMA, etc.), and in particular 3GPP NR, may be used by allocating the OFDM carrier data bit vectors to the corresponding symbol resources.

In some aspects, any of the UEs 101 and 102 can comprise an Internet-of-Things (IoT) UE or a Cellular IoT (CIoT) UE, which can comprise a network access layer designed for low-power IoT applications utilizing short-lived UE connections. In some aspects, any of the UEs 101 and 102 can include a narrowband (NB) IoT UE (e.g., such as an enhanced NB-IoT (eNB-IoT) UE and Further Enhanced (FeNB-IoT) UE). An IoT UE can utilize technologies such as machine-to-machine (M2M) or machine-type communications (MTC) for exchanging data with an MTC server or device via a public land mobile network (PLMN), Proximity-Based Service (ProSe) or device-to-device (D2D) communication, sensor networks, or IoT networks. The M2M or MTC exchange of data may be a machine-initiated exchange of data. An IoT network includes interconnecting IoT UEs, which may include uniquely identifiable embedded computing devices (within the Internet infrastructure), with short-lived connections. The IoT UEs may execute background applications (e.g., keep-alive messages, status updates, etc.) to facilitate the connections of the IoT network. In some aspects, any of the UEs 101 and 102 can include enhanced MTC (eMTC) UEs or further enhanced MTC (FeMTC) UEs.

The UEs 101 and 102 may be configured to connect, e.g., communicatively couple, with a radio access network (RAN) 110. The RAN 110 may be, for example, an Evolved Universal Mobile Telecommunications System (UMTS) Terrestrial Radio Access Network (E-UTRAN), a NextGen RAN (NG RAN), or some other type of RAN.

The UEs 101 and 102 utilize connections 103 and 104, respectively, each of which comprises a physical communications interface or layer (discussed in further detail below); in this example, the connections 103 and 104 are illustrated as an air interface to enable communicative coupling, and may be consistent with cellular communications protocols, such as a Global System for Mobile Communications (GSM) protocol, a code-division multiple access (CDMA) network protocol, a Push-to-Talk (PTT) protocol, a PTT over Cellular (POC) protocol, a Universal Mobile Telecommunications System (UMTS) protocol, a 3GPP Long Term Evolution (LTE) protocol, a 5G protocol, a 6G protocol, and the like.

In an aspect, the UEs 101 and 102 may further directly exchange communication data via a ProSe interface 105. The ProSe interface 105 may alternatively be referred to as a sidelink (SL) interface comprising one or more logical channels, including but not limited to a Physical Sidelink Control Channel (PSCCH), a Physical Sidelink Shared Channel (PSSCH), a Physical Sidelink Discovery Channel (PSDCH), a Physical Sidelink Broadcast Channel (PSBCH), and a Physical Sidelink Feedback Channel (PSFCH).

The UE 102 is shown to be configured to access an access point (AP) 106 via connection 107. The connection 107 can comprise a local wireless connection, such as, for example, a connection consistent with any IEEE 802.11 protocol, according to which the AP 106 can comprise a wireless fidelity (WiFi®) router. In this example, the AP 106 is shown to be connected to the Internet without connecting to the core network of the wireless system (described in further detail below).

The RAN 110 can include one or more access nodes that enable the connections 103 and 104. These access nodes (ANs) may be referred to as base stations (BSs), NodeBs, evolved NodeBs (eNBs), Next Generation NodeBs (gNBs), RAN nodes, and the like, and can comprise ground stations (e.g., terrestrial access points) or satellite stations providing coverage within a geographic area (e.g., a cell). In some aspects, the communication nodes 111 and 112 may be transmission/reception points (TRPs). In instances when the communication nodes 111 and 112 are NodeBs (e.g., eNBs or gNBs), one or more TRPs can function within the communication cell of the NodeBs. The RAN 110 may include one or more RAN nodes for providing macrocells, e.g., macro RAN node 111, and one or more RAN nodes for providing femtocells or picocells (e.g., cells having smaller coverage areas, smaller user capacity, or higher bandwidth compared to macrocells), e.g., low power (LP) RAN node 112.

Any of the RAN nodes 111 and 112 can terminate the air interface protocol and may be the first point of contact for the UEs 101 and 102. In some aspects, any of the RAN nodes 111 and 112 can fulfill various logical functions for the RAN 110 including, but not limited to, radio network controller (RNC) functions such as radio bearer management, uplink and downlink dynamic radio resource management and data packet scheduling, and mobility management. In an example, any of the nodes 111 and/or 112 may be a gNB, an eNB, or another type of RAN node.

The RAN 110 is shown to be communicatively coupled to a core network (CN) 120 via an S1 interface 113. In aspects, the CN 120 may be an evolved packet core (EPC) network, a NextGen Packet Core (NPC) network, or some other type of CN (e.g., as illustrated in reference to FIGS. 1B-1C). In this aspect, the S1 interface 113 is split into two parts: the S1-U interface 114, which carries traffic data between the RAN nodes 111 and 112 and the serving gateway (S-GW) 122, and the S1-mobility management entity (MME) interface 115, which is a signaling interface between the RAN nodes 111 and 112 and MMEs 121.

In this aspect, the CN 120 comprises the MMEs 121, the S-GW 122, the Packet Data Network (PDN) Gateway (P-GW) 123, and a home subscriber server (HSS) 124. The MMEs 121 may be similar in function to the control plane of legacy Serving General Packet Radio Service (GPRS) Support Nodes (SGSN). The MMEs 121 may manage mobility aspects in access such as gateway selection and tracking area list management. The HSS 124 may comprise a database for network users, including subscription-related information to support the network entities' handling of communication sessions. The CN 120 may comprise one or several HSSs 124, depending on the number of mobile subscribers, on the capacity of the equipment, on the organization of the network, etc. For example, the HSS 124 can provide support for routing/roaming, authentication, authorization, naming/addressing resolution, location dependencies, etc.

The S-GW 122 may terminate the S1 interface 113 towards the RAN 110, and routes data packets between the RAN 110 and the CN 120. In addition, the S-GW 122 may be a local mobility anchor point for inter-RAN node handovers and also may provide an anchor for inter-3GPP mobility. Other responsibilities of the S-GW 122 may include a lawful intercept, charging, and some policy enforcement.

The P-GW 123 may terminate an SGi interface toward a PDN. The P-GW 123 may route data packets between the CN 120 and external networks such as a network including the application server 184 (alternatively referred to as application function (AF)) via an Internet Protocol (IP) interface 125. The P-GW 123 can also communicate data to other external networks 131A, which can include the Internet, IP multimedia subsystem (IPS) network, and other networks. Generally, the application server 184 may be an element offering applications that use IP bearer resources with the core network (e.g., UMTS Packet Services (PS) domain, LTE PS data services, etc.). In this aspect, the P-GW 123 is shown to be communicatively coupled to an application server 184 via an IP interface 125. The application server 184 can also be configured to support one or more communication services (e.g., Voice-over-Internet Protocol (VoIP) sessions, PTT sessions, group communication sessions, social networking services, etc.) for the UEs 101 and 102 via the CN 120.

The P-GW 123 may further be a node for policy enforcement and charging data collection. Policy and Charging Rules Function (PCRF) 126 is the policy and charging control element of the CN 120. In a non-roaming scenario, in some aspects, there may be a single PCRF in the Home Public Land Mobile Network (HPLMN) associated with a UE's Internet Protocol Connectivity Access Network (IP-CAN) session. In a roaming scenario with a local breakout of traffic, there may be two PCRFs associated with a UE's IP-CAN session: a Home PCRF (H-PCRF) within an HPLMN and a Visited PCRF (V-PCRF) within a Visited Public Land Mobile Network (VPLMN). The PCRF 126 may be communicatively coupled to the application server 184 via the P-GW 123.

In some aspects, the communication network 140A may be an IoT network or a 5G or 6G network, including 5G new radio network using communications in the licensed (5G NR) and the unlicensed (5G NR-U) spectrum. One of the current enablers of IoT is the narrowband-IoT (NB-IoT). Operation in the unlicensed spectrum may include dual connectivity (DC) operation and the standalone LTE system in the unlicensed spectrum, according to which LTE-based technology solely operates in unlicensed spectrum without the use of an “anchor” in the licensed spectrum, called MulteFire. Further enhanced operation of LTE systems in the licensed as well as unlicensed spectrum is expected in future releases and 5G systems. Such enhanced operations can include techniques for sidelink resource allocation and UE processing behaviors for NR sidelink V2X communications.

An NG system architecture (or 6G system architecture) can include the RAN 110 and a 5G core network (5GC) 120. The NG-RAN 110 can include a plurality of nodes, such as gNBs and NG-eNBs. The CN 120 (e.g., a 5G core network/5GC) can include an access and mobility function (AMF) and/or a user plane function (UPF). The AMF and the UPF may be communicatively coupled to the gNBs and the NG-eNBs via NG interfaces. More specifically, in some aspects, the gNBs and the NG-eNBs may be connected to the AMF by NG-C interfaces, and to the UPF by NG-U interfaces. The gNBs and the NG-eNBs may be coupled to each other via Xn interfaces.

In some aspects, the NG system architecture can use reference points between various nodes. In some aspects, each of the gNBs and the NG-eNBs may be implemented as a base station, a mobile edge server, a small cell, a home eNB, and so forth. In some aspects, a gNB may be a master node (MN) and NG-eNB may be a secondary node (SN) in a 5G architecture.

FIG. 1B illustrates a non-roaming 5G system architecture in accordance with some aspects. In particular, FIG. 1B illustrates a 5G system architecture 140B in a reference point representation, which may be extended to a 6G system architecture. More specifically, UE 102 may be in communication with RAN 110 as well as one or more other 5GC network entities. The 5G system architecture 140B includes a plurality of network functions (NFs), such as an AMF 132, session management function (SMF) 136, policy control function (PCF) 148, application function (AF) 150, UPF 134, network slice selection function (NSSF) 142, authentication server function (AUSF) 144, and unified data management (UDM)/home subscriber server (HSS) 146.

The UPF 134 can provide a connection to a data network (DN) 152, which can include, for example, operator services, Internet access, or third-party services. The AMF 132 may be used to manage access control and mobility and can also include network slice selection functionality. The AMF 132 may provide UE-based authentication, authorization, mobility management, etc., and may be independent of the access technologies. The SMF 136 may be configured to set up and manage various sessions according to network policy. The SMF 136 may thus be responsible for session management and allocation of IP addresses to UEs. The SMF 136 may also select and control the UPF 134 for data transfer. The SMF 136 may be associated with a single session of a UE 101 or multiple sessions of the UE 101. This is to say that the UE 101 may have multiple 5G sessions. Different SMFs may be allocated to each session. The use of different SMFs may permit each session to be individually managed. As a consequence, the functionalities of each session may be independent of each other.

The UPF 134 may be deployed in one or more configurations according to the desired service type and may be connected with a data network. The PCF 148 may be configured to provide a policy framework using network slicing, mobility management, and roaming (similar to PCRF in a 4G communication system). The UDM may be configured to store subscriber profiles and data (similar to an HSS in a 4G communication system).

The AF 150 may provide information on the packet flow to the PCF 148 responsible for policy control to support a desired QoS. The PCF 148 may set mobility and session management policies for the UE 101. To this end, the PCF 148 may use the packet flow information to determine the appropriate policies for proper operation of the AMF 132 and SMF 136. The AUSF 144 may store data for UE authentication.

In some aspects, the 5G system architecture 140B includes an IP multimedia subsystem (IMS) 168B as well as a plurality of IP multimedia core network subsystem entities, such as call session control functions (CSCFs). More specifically, the IMS 168B includes a CSCF, which can act as a proxy CSCF (P-CSCF) 162B, a serving CSCF (S-CSCF) 164B, an emergency CSCF (E-CSCF) (not illustrated in FIG. 1B), or interrogating CSCF (I-CSCF) 166B. The P-CSCF 162B may be configured to be the first contact point for the UE 102 within the IM subsystem (IMS) 168B. The S-CSCF 164B may be configured to handle the session states in the network, and the E-CSCF may be configured to handle certain aspects of emergency sessions such as routing an emergency request to the correct emergency center or PSAP. The I-CSCF 166B may be configured to function as the contact point within an operator's network for all IMS connections destined to a subscriber of that network operator, or a roaming subscriber currently located within that network operator's service area. In some aspects, the I-CSCF 166B may be connected to another IP multimedia network 170B, e.g., an IMS operated by a different network operator.

In some aspects, the UDM/HSS 146 may be coupled to an application server 184, which can include a telephony application server (TAS) or another application server (AS) 160B. The AS 160B may be coupled to the IMS 168B via the S-CSCF 164B or the I-CSCF 166B.

A reference point representation shows that interaction can exist between corresponding NF services. For example, FIG. 1B illustrates the following reference points: N1 (between the UE 102 and the AMF 132), N2 (between the RAN 110 and the AMF 132), N3 (between the RAN 110 and the UPF 134), N4 (between the SMF 136 and the UPF 134), N5 (between the PCF 148 and the AF 150, not shown), N6 (between the UPF 134 and the DN 152), N7 (between the SMF 136 and the PCF 148, not shown), N8 (between the UDM 146 and the AMF 132, not shown), N9 (between two UPFs 134, not shown), N10 (between the UDM 146 and the SMF 136, not shown), N11 (between the AMF 132 and the SMF 136, not shown), N12 (between the AUSF 144 and the AMF 132, not shown), N13 (between the AUSF 144 and the UDM 146, not shown), N14 (between two AMFs 132, not shown), N15 (between the PCF 148 and the AMF 132 in case of a non-roaming scenario, or between the PCF 148 and a visited network and AMF 132 in case of a roaming scenario, not shown), N16 (between two SMFs, not shown), and N22 (between AMF 132 and NSSF 142, not shown). Other reference point representations not shown in FIG. 1B can also be used.

FIG. 1C illustrates a 5G system architecture 140C and a service-based representation. In addition to the network entities illustrated in FIG. 1B, system architecture 140C can also include a network exposure function (NEF) 154 and a network repository function (NRF) 156. In some aspects, 5G system architectures may be service-based and interaction between network functions may be represented by corresponding point-to-point reference points Ni or as service-based interfaces.

In some aspects, as illustrated in FIG. 1C, service-based representations may be used to represent network functions within the control plane that enable other authorized network functions to access their services. In this regard, 5G system architecture 140C can include the following service-based interfaces: Namf 158H (a service-based interface exhibited by the AMF 132), Nsmf 158I (a service-based interface exhibited by the SMF 136), Nnef 158B (a service-based interface exhibited by the NEF 154), Npcf 158D (a service-based interface exhibited by the PCF 148), a Nudm 158E (a service-based interface exhibited by the UDM 146), Naf 158F (a service-based interface exhibited by the AF 150), Nnrf 158C (a service-based interface exhibited by the NRF 156), Nnssf 158A (a service-based interface exhibited by the NSSF 142), Nausf 158G (a service-based interface exhibited by the AUSF 144). Other service-based interfaces (e.g., Nudr, N5g-eir, and Nudsf) not shown in FIG. 1C can also be used.

NR-V2X architectures may support high-reliability low latency sidelink communications with a variety of traffic patterns, including periodic and aperiodic communications with random packet arrival time and size. Techniques disclosed herein may be used for supporting high reliability in distributed communication systems with dynamic topologies, including sidelink NR V2X communication systems.

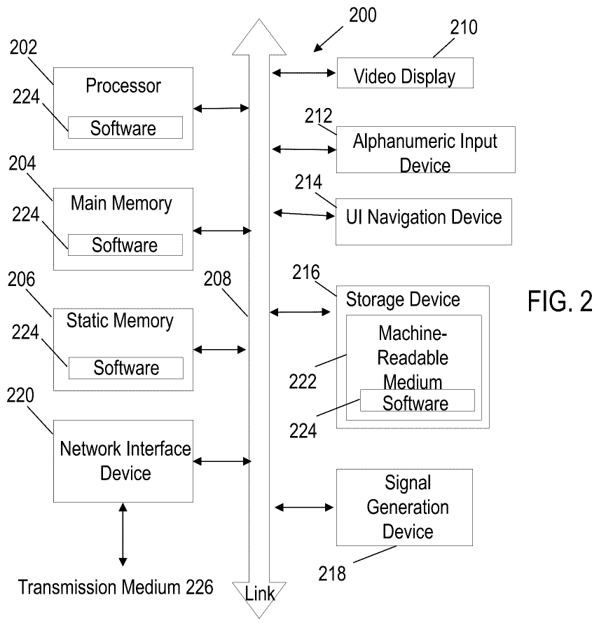

FIG. 2 illustrates a block diagram of a communication device in accordance with some embodiments. The communication device 200 may be a UE such as a specialized computer, a personal or laptop computer (PC), a tablet PC, or a smart phone, dedicated network equipment such as an eNB, a server running software to configure the server to operate as a network device, a virtual device, or any machine capable of executing instructions (sequential or otherwise) that specify actions to be taken by that machine. For example, the communication device 200 may be implemented as one or more of the devices shown in FIGS. 1A-1C. Note that communications described herein may be encoded before transmission by the transmitting entity (e.g., UE, gNB) for reception by the receiving entity (e.g., gNB, UE) and decoded after reception by the receiving entity.

Examples, as described herein, may include, or may operate on, logic or a number of components, modules, or mechanisms. Modules and components are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” (and “component”) is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

The communication device 200 may include a hardware processor (or equivalently processing circuitry) 202 (e.g., a central processing unit (CPU), a GPU, a hardware processor core, or any combination thereof), a main memory 204 and a static memory 206, some or all of which may communicate with each other via an interlink (e.g., bus) 208. The main memory 204 may contain any or all of removable storage and non-removable storage, volatile memory or non-volatile memory. The communication device 200 may further include a display unit 210 such as a video display, an alphanumeric input device 212 (e.g., a keyboard), and a user interface (UI) navigation device 214 (e.g., a mouse). In an example, the display unit 210, input device 212 and UI navigation device 214 may be a touch screen display. The communication device 200 may additionally include a storage device (e.g., drive unit) 216, a signal generation device 218 (e.g., a speaker), a network interface device 220, and one or more sensors, such as a global positioning system (GPS) sensor, compass, accelerometer, or another sensor. The communication device 200 may further include an output controller, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 216 may include a non-transitory machine readable medium 222 (hereinafter simply referred to as machine readable medium) on which is stored one or more sets of data structures or instructions 224 (e.g., software) embodying or utilized by any one or more of the techniques or functions described herein. The non-transitory machine readable medium 222 is a tangible medium. The instructions 224 may also reside, completely or at least partially, within the main memory 204, within static memory 206, and/or within the hardware processor 202 during execution thereof by the communication device 200. While the machine readable medium 222 is illustrated as a single medium, the term “machine readable medium” may include a single medium or multiple media (e.g., a centralized or distributed database, and/or associated caches and servers) configured to store the one or more instructions 224.

The term “machine readable medium” may include any medium that is capable of storing, encoding, or carrying instructions for execution by the communication device 200 and that cause the communication device 200 to perform any one or more of the techniques of the present disclosure, or that is capable of storing, encoding or carrying data structures used by or associated with such instructions. Non-limiting machine-readable medium examples may include solid-state memories, and optical and magnetic media. Specific examples of machine-readable media may include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks.

The instructions 224 may further be transmitted or received over a communications network using a transmission medium 226 via the network interface device 220 utilizing any one of a number of wireless local area network (WLAN) transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks. Communications over the networks may include one or more different protocols, such as Institute of Electrical and Electronics Engineers (IEEE) 802.11 family of standards known as Wi-Fi, IEEE 802.16 family of standards known as WiMax, IEEE 802.15.4 family of standards, a Long Term Evolution (LTE) family of standards, a Universal Mobile Telecommunications System (UMTS) family of standards, peer-to-peer (P2P) networks, a next generation (NG)/5^{th} generation (5G) standards among others. In an example, the network interface device 220 may include one or more physical jacks (e.g., Ethernet, coaxial, or phone jacks) or one or more antennas to connect to the transmission medium 226.

Note that the term “circuitry” as used herein refers to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable SoC), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” or “processor” as used herein thus refers to, is part of, or includes circuitry capable of sequentially and automatically carrying out a sequence of arithmetic or logical operations, or recording, storing, and/or transferring digital data. The term “processor circuitry” or “processor” may refer to one or more application processors, one or more baseband processors, a physical central processing unit (CPU), a single- or multi-core processor, and/or any other device capable of executing or otherwise operating computer-executable instructions, such as program code, software modules, and/or functional processes.

Any of the radio links described herein may operate according to any one or more of the following radio communication technologies and/or standards including but not limited to: a Global System for Mobile Communications (GSM) radio communication technology, a General Packet Radio Service (GPRS) radio communication technology, an Enhanced Data Rates for GSM Evolution (EDGE) radio communication technology, and/or a Third Generation Partnership Project (3GPP) radio communication technology, for example Universal Mobile Telecommunications System (UMTS), Freedom of Multimedia Access (FOMA), 3GPP Long Term Evolution (LTE), 3GPP Long Term Evolution Advanced (LTE Advanced), Code division multiple access 2000 (CDMA2000), Cellular Digital Packet Data (CDPD), Mobitex, Third Generation (3G), Circuit Switched Data (CSD), High-Speed Circuit-Switched Data (HSCSD), Universal Mobile Telecommunications System (Third Generation) (UMTS (3G)), Wideband Code Division Multiple Access (Universal Mobile Telecommunications System) (W-CDMA (UMTS)), High Speed Packet Access (HSPA), High-Speed Downlink Packet Access (HSDPA), High-Speed Uplink Packet Access (HSUPA), High Speed Packet Access Plus (HSPA+), Universal Mobile Telecommunications System-Time-Division Duplex (UMTS-TDD), Time Division-Code Division Multiple Access (TD-CDMA), Time Division-Synchronous Code Division Multiple Access (TD-CDMA), 3rd Generation Partnership Project Release 8 (Pre-4th Generation) (3GPP Rel. 8 (Pre-4G)), 3GPP Rel. 9 (3rd Generation Partnership Project Release 9), 3GPP Rel. 10 (3rd Generation Partnership Project Release 10), 3GPP Rel. 11 (3rd Generation Partnership Project Release 11), 3GPP Rel. 12 (3rd Generation Partnership Project Release 12), 3GPP Rel. 13 (3rd Generation Partnership Project Release 13), 3GPP Rel. 14 (3rd Generation Partnership Project Release 14), 3GPP Rel. 15 (3rd Generation Partnership Project Release 15), 3GPP Rel. 16 (3rd Generation Partnership Project Release 16), 3GPP Rel. 17 (3rd Generation Partnership Project Release 17) and subsequent Releases (such as Rel. 18, Rel. 19, etc.), 3GPP 5G, 5G, 5G New Radio (5G NR), 3GPP 5G New Radio, 3GPP LTE Extra, LTE-Advanced Pro, LTE Licensed-Assisted Access (LAA), MuLTEfire, UMTS Terrestrial Radio Access (UTRA), Evolved UMTS Terrestrial Radio Access (E-UTRA), Long Term Evolution Advanced (4th Generation) (LTE Advanced (4G)), cdmaOne (2G), Code division multiple access 2000 (Third generation) (CDMA2000 (3G)), Evolution-Data Optimized or Evolution-Data Only (EV-DO), Advanced Mobile Phone System (1st Generation) (AMPS (1G)), Total Access Communication System/Extended Total Access Communication System (TACS/ETACS), Digital AMPS (2nd Generation) (D-AMPS (2G)), Push-to-talk (PTT), Mobile Telephone System (MTS), Improved Mobile Telephone System (IMTS), Advanced Mobile Telephone System (AMTS), OLT (Norwegian for Offentlig Landmobil Telefoni, Public Land Mobile Telephony), MTD (Swedish abbreviation for Mobiltelefonisystem D, or Mobile telephony system D), Public Automated Land Mobile (Autotel/PALM), ARP (Finnish for Autoradiopuhelin, “car radio phone”), NMT (Nordic Mobile Telephony), High capacity version of NTT (Nippon Telegraph and Telephone) (Hicap), Cellular Digital Packet Data (CDPD), Mobitex, DataTAC, Integrated Digital Enhanced Network (iDEN), Personal Digital Cellular (PDC), Circuit Switched Data (CSD), Personal Handy-phone System (PHS), Wideband Integrated Digital Enhanced Network (WiDEN), iBurst, Unlicensed Mobile Access (UMA), also referred to as 3GPP Generic Access Network, or GAN standard), Zigbee, Bluetooth(r), Wireless Gigabit Alliance (WiGig) standard, mmWave standards in general (wireless systems operating at 10-300 GHz and above such as WiGig, IEEE 802.11ad, IEEE 802.11ay, etc.), technologies operating above 300 GHz and THz bands, (3GPP/LTE based or IEEE 802.11p or IEEE 802.11bd and other) Vehicle-to-Vehicle (V2V) and Vehicle-to-X (V2X) and Vehicle-to-Infrastructure (V2I) and Infrastructure-to-Vehicle (I2V) communication technologies, 3GPP cellular V2X, DSRC (Dedicated Short Range Communications) communication systems such as Intelligent-Transport-Systems and others (typically operating in 5850 MHz to 5925 MHz or above (typically up to 5935 MHz following change proposals in CEPT Report 71)), the European ITS-G5 system (i.e. the European flavor of IEEE 802.11p based DSRC, including ITS-G5A (i.e., Operation of ITS-G5 in European ITS frequency bands dedicated to ITS for safety related applications in the frequency range 5,875 GHz to 5,905 GHz), ITS-G5B (i.e., Operation in European ITS frequency bands dedicated to ITS non-safety applications in the frequency range 5,855 GHz to 5,875 GHz), ITS-G5C (i.e., Operation of ITS applications in the frequency range 5,470 GHz to 5,725 GHz)), DSRC in Japan in the 700 MHz band (including 715 MHz to 725 MHz), IEEE 802.11bd based systems, etc.

Aspects described herein may be used in the context of any spectrum management scheme including dedicated licensed spectrum, unlicensed spectrum, license exempt spectrum, (licensed) shared spectrum (such as LSA=Licensed Shared Access in 2.3-2.4 GHz, 3.4-3.6 GHz, 3.6-3.8 GHz and further frequencies and SAS=Spectrum Access System/CBRS=Citizen Broadband Radio System in 3.55-3.7 GHz and further frequencies). Applicable spectrum bands include IMT (International Mobile Telecommunications) spectrum as well as other types of spectrum/bands, such as bands with national allocation (including 450-470 MHz, 902-928 MHz (note: allocated for example in US (FCC Part 15)), 863-868.6 MHz (note: allocated for example in European Union (ETSI EN 300 220)), 915.9-929.7 MHz (note: allocated for example in Japan), 917-923.5 MHz (note: allocated for example in South Korea), 755-779 MHz and 779-787 MHz (note: allocated for example in China), 790-960 MHz, 1710-2025 MHz, 2110-2200 MHz, 2300-2400 MHz, 2.4-2.4835 GHz (note: it is an ISM band with global availability and it is used by Wi-Fi technology family (11b/g/n/ax) and also by Bluetooth), 2500-2690 MHz, 698-790 MHz, 610-790 MHz, 3400-3600 MHz, 3400-3800 MHz, 3800-4200 MHz, 3.55-3.7 GHz (note: allocated for example in the US for Citizen Broadband Radio Service), 5.15-5.25 GHz and 5.25-5.35 GHz and 5.47-5.725 GHz and 5.725-5.85 GHz bands (note: allocated for example in the US (FCC part 15), consists four U-NII bands in total 500 MHz spectrum), 5.725-5.875 GHz (note: allocated for example in EU (ETSI EN 301 893)), 5.47-5.65 GHz (note: allocated for example in South Korea, 5925-7125 MHz and 5925-6425 MHz band (note: under consideration in US and EU, respectively. Next generation Wi-Fi system is expected to include the 6 GHz spectrum as operating band, but it is noted that, as of December 2017, Wi-Fi system is not yet allowed in this band. Regulation is expected to be finished in 2019-2020 time frame), IMT-advanced spectrum, IMT-2020 spectrum (expected to include 3600-3800 MHz, 3800-4200 MHz, 3.5 GHz bands, 700 MHz bands, bands within the 24.25-86 GHz range, etc.), spectrum made available under FCC's “Spectrum Frontier” 5G initiative (including 27.5-28.35 GHz, 29.1-29.25 GHz, 31-31.3 GHz, 37-38.6 GHz, 38.6-40 GHz, 42-42.5 GHz, 57-64 GHz, 71-76 GHz, 81-86 GHz and 92-94 GHz, etc.), the ITS (Intelligent Transport Systems) band of 5.9 GHz (typically 5.85-5.925 GHz) and 63-64 GHz, bands currently allocated to WiGig such as WiGig Band 1 (57.24-59.40 GHz), WiGig Band 2 (59.40-61.56 GHz) and WiGig Band 3 (61.56-63.72 GHz) and WiGig Band 4 (63.72-65.88 GHz), 57-64/66 GHz (note: this band has near-global designation for Multi-Gigabit Wireless Systems (MGWS)/WiGig. In US (FCC part 15) allocates total 14 GHz spectrum, while EU (ETSI EN 302 567 and ETSI EN 301 217-2 for fixed P2P) allocates total 9 GHz spectrum), the 70.2 GHz-71 GHz band, any band between 65.88 GHz and 71 GHz, bands currently allocated to automotive radar applications such as 76-81 GHz, and future bands including 94-300 GHz and above. Furthermore, the scheme may be used on a secondary basis on bands such as the TV White Space bands (typically below 790 MHz) where in particular the 400 MHz and 700 MHz bands are promising candidates. Besides cellular applications, specific applications for vertical markets may be addressed such as PMSE (Program Making and Special Events), medical, health, surgery, automotive, low-latency, drones, etc. applications.

As above, it is desirable to improve the manner in which a UE, like a smartphone or IoT device, determines its location within a wireless network. Traditionally, the UE and CN use one or more methods to figure out where the UE is located. However, these methods can be limited in accuracy and efficiency, especially in dynamic environments like those involving autonomous vehicles.

In the 3GPP architecture, Location Services (LCS) refer to a set of functionalities that enable the determination of the geographical position of UE within a mobile network. LCS is designed to support a variety of applications, including emergency services, location-based services, and network optimization. The LCS structure uses Location Measurement Units (LMUs), a LCS client, Gateway Mobile Location Center (GMLC), and a Serving Mobile Location Center (SMLC). The LMUs are network elements that assist in measuring the location of UEs and can be integrated into base stations or operate as standalone units. The LCS client is an entity that requests the location information, and can be an application running on the UE or a network-based application. The GMLC is a central component in the LCS architecture that acts as the interface between the external LCS clients and the mobile network. The GMLC handles location requests and coordinates with other network elements to obtain the location information. The SMLC is responsible for calculating the position of the UE. The SMLC uses measurements from the LMUs and other network data to determine the location.

3GPP LCS supports various positioning methods, including Cell-ID, Enhanced Cell-ID, Observed Time Difference of Arrival (OTDOA), and Assisted Global Navigation Satellite System (A-GNSS). These methods vary in terms of accuracy and the type of data used. LCS utilizes specific protocols for communication between network elements and the LCS client, such as the Mobile Location Protocol (MLP) and the Location Services Protocol (LSP).

AI/ML-based positioning may be used to improve the accuracy and efficiency of location methods. Considerations for determining whether and how an AI/ML model for may be used for direct AI/ML positioning include identifying the entity responsible for training the model and determining how the model is shared with the consumer if the training entity and the consumer are different. Additionally, it is useful to understand how the model consumer utilizes the trained model to perform inference and derive the UE's position. The process may also include defining procedures for data collection aimed at training AI/ML models for direct AI/ML positioning, as well as exploring whether and how direct AI/ML positioning can be supported with additional enhancements to the 5GC. Moreover, monitoring the performance of ML models used for direct AI/ML-based positioning may be used to ensure the ML models effectiveness and reliability.

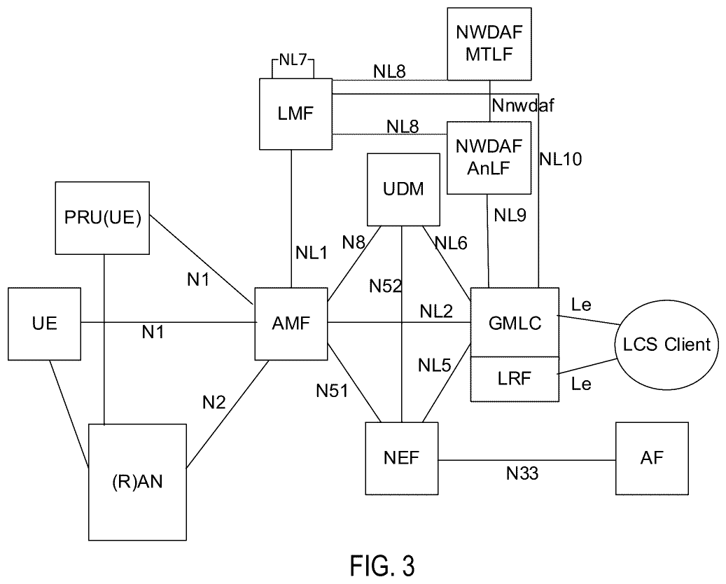

FIG. 3 illustrates a system architecture in accordance with some aspects. Many of the individual components of the 3GPP architecture are replicated from FIGS. 1B and 1C, so are not described herein. The components include a Network Data Analytics Function (NWDAF), which enhances network operations through data analytics and provides insights and analytics derived from network data to support AI/ML-based positioning. In particular, the NWDAF collects data from various network elements, such as the Location Management Function (LMF) and NG-RAN nodes (e.g., gNB or NG-eNB). This data includes location information and measurements for training and inference of ML models.

The LMF receives measurements and assistance information from the NG-RAN and the UE via the AMF over the NLs interface to compute the position of the UE. Due to the new next generation interface between the NG-RAN and the core network, the NR positioning protocol a (NRPPa) protocol carries the positioning information between NG-RAN and LMF over the next generation control plane interface (NG-C).

The NWDAF is divided into two main components: an NWDAF containing a Model Training Logical Function (MTLF) and an NWDAF containing Analytics Logical Function (AnLF). The MTLF is responsible for training the ML model used for UE positioning analytics. The NWDAF containing the MTLF receives input data for training from the LMF, which collects location information or measurements from the UE using the LTE Positioning Protocol (LPP) and from the NG-RAN node using the NRPPa. The NWDAF containing the MTLF uses the collected data to develop models that can accurately predict or analyze UE positioning. The NWDAF containing the MTLF processes various input data types, including radio measurement data including Reference Signal Received Power (RSRP) values, Timing Advance (TA) measurements from multiple gNBs/NG-RAN nodes, signal quality indicators such as signal-to-interference-plus-noise ratio (SINR) measurements, and/or cell ID information and neighboring cell measurements.

The AnLF performs inference using the trained ML model to derive UE positioning analytics. The AnLF acts based on requests from the NWDAF consumer, which may be the LMF. The AnLF uses the real-time input data provided by the LMF to perform the analytics and deliver accurate positioning information. The inference process executed by the NWDAF containing AnLF includes: real-time processing of positioning measurement data, application of trained model weights to input features, generation of position estimates with associated confidence metrics, and correlation of multiple measurement sources for enhanced accuracy.

The positioning procedure over the user plane (using LTE Positioning Protocol (LPP)) may be used for data collection (location information or measurements from UE) from UE by the LMF for ML model training. The positioning procedure (using NR Positioning Protocol a (NRPPa)) may be used for data collection (location information or measurements from NG-RAN node) from the NG-RAN node (gNB or NG-eNB) by the LMF for the ML model training. In some embodiment, the positioning procedure over the user plane may be used for data collection (location information or measurements from UE) from UE by the NWDAF containing MTLF for ML model training. In the latter case, the data may be supplied directly from the UE without being provided by the LMF.

The LMF, which as above may be the consumer for UE positioning analytics, also provides the input data for inference to the NWDAF containing the AnLF. In some embodiment, the positioning procedure over the user plane (using LPP) may be used for data collection (location information or measurements from UE) from the UE by the LMF for inference. Further, the positioning procedure (using NR Positioning Protocol a (NRPPa)) may be used for data collection (location information or measurements from NG-RAN node) from NG-RAN node (gNB or NG-eNB) by the LMF for inference. In some embodiment, the LMF and NWDAF containing AnLF may be co-located.

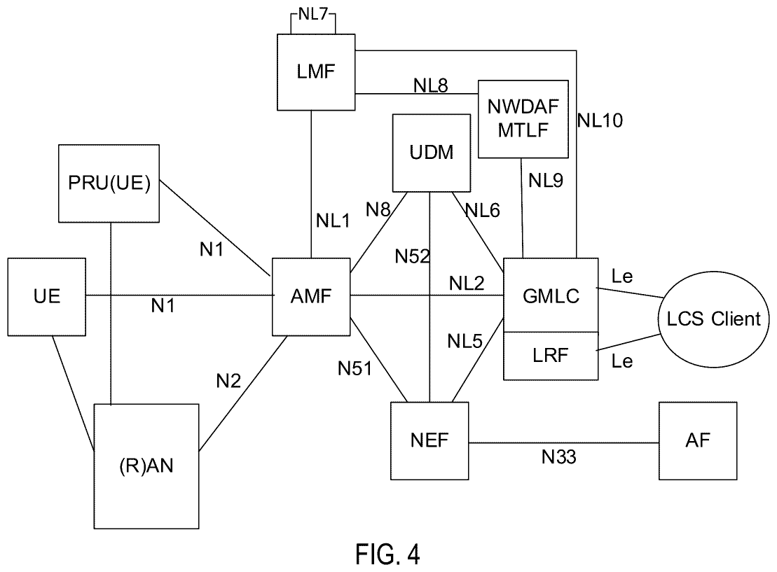

FIG. 4 illustrates a system architecture in accordance with some aspects. Certain aspects of the architecture in FIG. 4 are similar to that of FIG. 3. As in FIG. 3, the NWDAF containing the MTLF trains the ML model for UE positioning analytics. However, the LMF performs the inference, derives UE positioning analytics and is the consumer for ML training services provided by the NWDAF containing MTLF. Thus, the trained ML model used by the LMF for inference is provided by the NWDAF containing the MTLF. The input data used for training the ML model for UE positioning analytics is provided by the LMF while the input data for inference by the ML model in the LMF is provided by the NG-RAN node (e.g., gNB) or UE.

Whether the LMF uses an AI/ML based positioning procedure, or the existing UE-assisted or network-assisted positioning procedure is an implementation decision applicable to both of the architectures shown in FIGS. 3 and 4. Each of the architectures shown in FIGS. 3 and 4 system supports multiple positioning methods, including direct ML-based positioning using raw radio measurements, hybrid approaches combining traditional and ML-based techniques, and adaptive selection between positioning methods based on available input data.

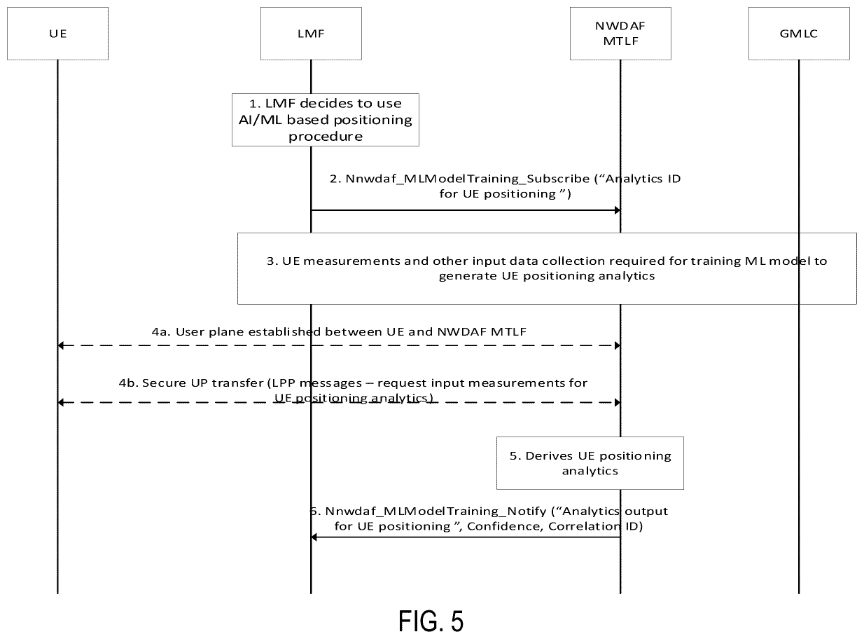

FIG. 5 illustrates the model training procedure in accordance with some aspects. When the LMF decides to use the AI/ML based positioning method, the procedure shown in FIG. 5 may be followed to request the trained ML model training UE positioning analytics by the LMF.

The LMF decision phase is shown as operation 1. The LMF evaluates whether to use AI/ML based positioning method. The decision at operation 1 may initiate a training procedure sequence.

At operation 2, the LMF implements a training subscription. The LMF sends an Nnwdaf_MLModel Training_Subscribe request to the NWDAF containing the MTLF. The request includes an analytics ID specifically for UE positioning and establishes a subscription for ML model training services. A connection is established between the LMF and the NWDAF containing the MTLF.

Operation 3 is a data collection phase in which the system gathers UE measurements and input data used for ML model training. The data collected may include user plane measurements via LPP protocol, network measurements via the NRPPa protocol, and location information from the NG-RAN nodes.

Operations 4a and 4b are data transfer operations. In particular, user plane establishment between the UE and the NWDAF containing the MTLF occurs during operation 4a. At operation 4b, the secure transfer of LPP messages occurs between the UE and the NWDAF containing the MTLF using a secure transfer channel created for the LPP messages. The LPP messages include both the request for input measurements specific to UE positioning analytics and UE positioning analytics data sent in response to the request. The data transmission through the established secure channels may be protected through encryption and other mechanisms.

Analytics processing occurs at operation 5. The NWDAF containing the MTLF derives UE positioning analytics during operation 5 by processing the collected measurement data and applying the AI/ML training algorithms.

The notification phase occurs at operation 6. The NWDAF containing the MTLF sends an Nnwdaf_MLModel Training_Notify message to the LMF. The Nnwdaf_MLModel Training_Notify message contains the analytics output for UE positioning, confidence metrics, and a correlation ID for tracking.

The procedure supports co-location configurations in which the LMF may be co-located with the NWDAF containing AnLF, the LMF may be co-located with NWDAF containing the MTLF, and the AI/ML based positioning model training and inference functionality may be integrated within the LMF. The AI/ML based positioning ML model training and inference functionality is supported by the LMF to support Location Services.

Thus, in the architecture shown in FIG. 3, the system supports AI/ML-based positioning in the 5G) by utilizing the LMF and the NWDAF within the 5GC. The NWDAF, which contains the MTLF, is responsible for training a ML model specifically for UE positioning analytics. Once trained, the NWDAF containing the AnLF performs inference to derive UE positioning analytics based on requests from the LMF. The input data for training the ML model is provided by the LMF. This data collection involves using the LPP over the user plane to gather location information or measurements from the UE. Additionally, the NRPPa is used to collect data from NG-RAN nodes for ML model training. The LMF, as the consumer of UE positioning analytics, also supplies the input data for inference to the NWDAF containing the AnLF. For inference, the LMF uses the LPP over the user plane to collect data from the UE and the NRPPa to gather data from NG-RAN nodes.

In the architecture shown in FIG. 4, the NWDAF containing the MTLF trains the ML model for UE positioning analytics, while the LMF performs the inference and derives UE positioning analytics. The LMF acts as the consumer of ML training services provided by the NWDAF containing the MTLF. The trained ML model for inference by the LMF is supplied by the NWDAF containing the MTLF. The input data for training the ML model is provided by the LMF. For inference, the input data is provided by either the NG-RAN node (e.g., gNB) or the UE, using the NRPPa or LPP, respectively, for data collection. In this architecture, the LMF may be co-located with the NWDAF containing both the AnLF and the MTLF, supporting both AI/ML-based positioning ML model training and inference.

Thus, the LMF may calculate the UE location and estimate the achieved accuracy by using LMF-based AI/ML Positioning. When receiving the request for a UE location, the LMF selects an appropriate positioning method to determine the result of the positioning. The result of the positioning may be calculated by using LMF-based AI/ML Positioning ML model supported by the LMF. The LMF collects input data from UE or NG-RAN for the LMF-based AI/ML Positioning to perform location calculation and provide the location to the consumer. The ML model that is used for LMF-based AI/ML Positioning in LMF may be trained by the NWDAF containing the MTLF or by the LMF. The trigger for data collection and model training in LMF is up to implementation. The LMF may also request a trained ML model for LMF-based AI/ML Positioning from NWDAF containing MTLF. The LMF discovers a suitable NWDAF containing MTLF via the NRF. The NWDAF containing MTLF collects input data to perform the ML model training, and the NWDAF containing MTLF performs ML model provision to the LMF. The NWDAF provides the ML Model identifier and ML Model Information for the ML Model for UE Positioning and indication of whether the ML Model identifier is updated if model is retrained and may also provide ML Model accuracy information. Once the ML model for LMF-based AI/ML Positioning is trained and located in the LMF, the LMF may use the ML model to perform UE Positioning after receiving a location determination request from the AMF. For training, performance monitoring and UE positioning calculation using LMF-based AI/ML Positioning, the LMF checks the user consent status with the UDM before collecting UE related data. Either LMF or NWDAF containing MTLF may perform performance monitoring for LMF-based AI/ML Positioning. When the ML model that is used for LMF-based AI/ML Positioning is trained by LMF the LMF monitors the performance of the ML model. When the ML model that is used for LMF-based AI/ML Positioning in LMF is trained by NWDAF containing MTLF, then the NWDAF containing MTLF monitors the performance of the ML model. The LMF may determine whether to use the LMF-based AI/ML Positioning to perform location calculation based on the model performance monitoring result. The LMF may also trigger the ML model retraining in the training entity based on the result of model performance result.

The LMF may retrieve a trained AI/ML Model from the NWDAF. The LMF obtains a trained AI/ML model prior to responding to a UE positioning request that uses a trained ML Model. In this case, the LMF determines, using local policies, that a positioning method is to use a trained ML Model, the trained ML Model is not trained locally but is retrieved from the NWDAF. The LMF then discovers the NWDAF that can provide a trained model, using Nnrf_NFdiscovery including a request for AI/ML Model for UE positioning, ML Model Filter Information that includes the positioning case information and an Area(s) of Interest, the ML Model Interoperability indicator applicable to the trained ML Model for UE Positioning, and may include the ML Model Accuracy checking capability. The LMF next receives a list of candidates NWDAF instances, validity period for the discovery, per NWDAF instance the NWDAF instance ID, fully qualified domain name (FQDN) or IP address, and the ML Model Interoperability Indication. The LMF subsequently selects a NWDAF, out of the list of candidates NWDAF instances, that can provide a ML Model that supports the same ML Model Interoperability Indication then request a trained AI/ML Model using Nnwdaf_MLModelInfo_Request or Nnwdaf_MLModelProvision_Subscribe including the request for a trained AI/ML Model for UE Positioning. The NWDAF provides one or more AI/ML Models to the LMF including a ML Model Identifier and the ML Model Information. The NWDAF may also provide the one or more AI/ML Models to the LMF using Nnwdaf_MLModelProvision_Notify.

### Examples

Example 1 is an apparatus of a Network Data Analytics Function (NWDAF) containing a Model Training Logical Function (MTLF), the apparatus comprising a processor that configures the apparatus to: receive, from a Location Management Function (LMF), a machine learning (ML) model training subscription request for a trained ML model for user equipment (UE) positioning; train a ML model for UE positioning using data of a UE; and after training the ML model, transmit the trained ML model to the LMF.

In Example 2, the subject matter of Example 1 includes, wherein: the processor further configures the apparatus to receive the data for training the ML model from the LMF, and the data comprises location information and measurements collected by the LMF from the UE and a next generation radio access network (NG-RAN) node.

In Example 3, the subject matter of Examples 1-2 includes, wherein the LMF uses the trained ML model to determine a position of the UE.

In Example 4, the subject matter of Examples 1-3 includes, wherein data used to determine UE location is provided from at least one of the UE or a next generation radio access network (NG-RAN) node.

In Example 5, the subject matter of Examples 1-4 includes, wherein the processor further configures the apparatus to provide the trained ML model to the LMF in a subscription response or notification message.

In Example 6, the subject matter of Examples 1-5 includes, wherein whether the trained ML model for UE positioning or legacy UE positioning is used is determined by the LMF.

In Example 7, the subject matter of Examples 1-6 includes, wherein the processor further configures the apparatus to monitor performance metrics of the trained ML model, and retraining of the trained ML model is initiated based on the monitored performance metrics.

In Example 8, the subject matter of Examples 1-7 includes, wherein the positioning measurements comprise: location information from the UE collected using long term evolution (LTE) Positioning Protocol (LPP) messages, and location information from next generation radio access network (NG-RAN) nodes collected using new radio (NR) Positioning Protocol a (NRPPa).

In Example 9, the subject matter of Examples 1-8 includes, wherein: a Network Data Analytics Function Analytics Logic Function (NWDAF AnLF) is co-located with the LMF, and one of the NWDAF AnLF or the LMF performs inference operations for positioning analytics.

In Example 10, the subject matter of Examples 1-9 includes, wherein the processor further configures the apparatus to establish a secure user plane transfer channel to receive long term evolution (LTE) Positioning Protocol (LPP) messages containing the positioning measurements.

Example 11 is an apparatus of a Location Management Function (LMF), the apparatus comprising a processor that configures the apparatus to: send, to a Network Data Analytics Function (NWDAF) containing a Model Training Logical Function (MTLF), a machine learning (ML) model training subscription request for a trained ML model for user equipment (UE) positioning; receive, from the NWDAF containing the MTLF, a trained ML model for UE positioning analytics trained using data of a UE; and use the trained ML model to determine a position of the UE in response to reception of a positioning request.

In Example 12, the subject matter of Example 11 includes, wherein: the processor further configures the apparatus to send the data to train a ML model to the NWDAF containing the MTLF to provide the trained ML model, and the data comprises location information and measurements collected by the LMF from the UE and next generation radio access network (NG-RAN) nodes.

In Example 13, the subject matter of Examples 11-12 includes, wherein: performance metrics of the trained ML model are monitored by the NWDAF containing the MTLF; and receive, from the NWDAF containing the MTLF, an updated trained ML model that is retrained based on the monitored performance metrics.

In Example 14, the subject matter of Examples 11-13 includes, wherein the processor further configures the apparatus to send, to the NWDAF containing the MTLF, location data collected from at least one of the UE or a next generation radio access network (NG-RAN) node.

In Example 15, the subject matter of Examples 11-14 includes, wherein the processor further configures the apparatus to send the ML model training subscription request in response to a determination to use the trained ML model to perform a location calculation of the UE.

In Example 16, the subject matter of Examples 11-15 includes, wherein the processor further configures the apparatus to: monitor performance metrics of the trained ML model; and initiate retraining of the trained ML model based on the monitored performance metrics.

In Example 17, the subject matter of Examples 11-16 includes, wherein the positioning measurements comprise: location information from the UE collected using long term evolution (LTE) Positioning Protocol (LPP) messages, and location information from next generation radio access network (NG-RAN) nodes collected using new radio (NR) Positioning Protocol a (NRPPa).

In Example 18, the subject matter of Examples 11-17 includes, wherein the processor further configures the apparatus to determine which of the trained ML model or legacy positioning is to be used for UE positioning.

Example 19 is a non-transitory computer-readable storage medium that stores instructions for execution by one or more processors of an apparatus of a Network Data Analytics Function (NWDAF) containing a Model Training Logical Function (MTLF), the instructions, when executed, configured to cause the apparatus to: receive, from a Location Management Function (LMF), a machine learning (ML) model training subscription request for a trained ML model for user equipment (UE) positioning; train a ML model for UE positioning analytics using data of a UE; and after training the ML model, transmit the ML model to the LMF to determine a position of the UE.

In Example 20, the subject matter of Example 19 includes, wherein: the instructions, when executed, configure the apparatus to receive the data for training the ML model from the LMF, and the data comprises location information and measurements collected by the LMF from the UE and a next generation radio access network (NG-RAN) node.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

Although an embodiment has been described with reference to specific example embodiments, it will be evident that various modifications and changes may be made to these embodiments without departing from the broader scope of the present disclosure. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

The subject matter may be referred to herein, individually and/or collectively, by the term “embodiment” merely for convenience and without intending to voluntarily limit the scope of this application to any single inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

In this document, the terms “a” or “an” are used, as is common in patent documents, to indicate one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, UE, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects. As indicated herein, although the term “a” is used herein, one or more of the associated elements may be used in different embodiments. For example, the term “a processor” configured to carry out specific operations includes both a single processor configured to carry out all of the operations as well as multiple processors individually configured to carry out some or all of the operations (which may overlap) such that the combination of processors carry out all of the operations. Further, the term “includes” may be considered to be interpreted as “includes at least” the elements that follow.

The Abstract of the Disclosure is submitted with the understanding that it will not be used to interpret or limit the scope or meaning of the claims. In addition, in the foregoing Detailed Description, it may be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. An apparatus of a Network Data Analytics Function (NWDAF) containing a Model Training Logical Function (MTLF), the apparatus comprising a processor that configures the apparatus to:
receive, from a Location Management Function (LMF), a machine learning (ML) model training subscription request for a trained ML model for user equipment (UE) positioning;
train a ML model for UE positioning using data of a UE; and
after training the ML model, transmit the trained ML model to the LMF.

2. The apparatus of claim 1, wherein:
the processor further configures the apparatus to receive the data for training the ML model from the LMF, and
the data comprises location information and measurements collected by the LMF from the UE and a next generation radio access network (NG-RAN) node.

3. The apparatus of claim 1, wherein the LMF uses the trained ML model to determine a position of the UE.

4. The apparatus of claim 1, wherein data used to determine UE location is provided from at least one of the UE or a next generation radio access network (NG-RAN) node.

5. The apparatus of claim 1, wherein the processor further configures the apparatus to provide the trained ML model to the LMF in a subscription response or notification message.

6. The apparatus of claim 1, wherein whether the trained ML model for UE positioning or legacy UE positioning is used is determined by the LMF.

7. The apparatus of claim 1, wherein the processor further configures the apparatus to monitor performance metrics of the trained ML model, and retraining of the trained ML model is initiated based on the monitored performance metrics.

8. The apparatus of claim 1, wherein the positioning measurements comprise:
location information from the UE collected using long term evolution (LTE) Positioning Protocol (LPP) messages, and
location information from next generation radio access network (NG-RAN) nodes collected using new radio (NR) Positioning Protocol a (NRPPa).

9. The apparatus of claim 1, wherein:
a Network Data Analytics Function Analytics Logic Function (NWDAF AnLF) is co-located with the LMF, and
one of the NWDAF AnLF or the LMF performs inference operations for positioning analytics.

10. The apparatus of claim 1, wherein the processor further configures the apparatus to establish a secure user plane transfer channel to receive long term evolution (LTE) Positioning Protocol (LPP) messages containing the positioning measurements.

11. An apparatus of a Location Management Function (LMF), the apparatus comprising a processor that configures the apparatus to:
send, to a Network Data Analytics Function (NWDAF) containing a Model Training Logical Function (MTLF), a machine learning (ML) model training subscription request for a trained ML model for user equipment (UE) positioning;
receive, from the NWDAF containing the MTLF, a trained ML model for UE positioning analytics trained using data of a UE; and
use the trained ML model to determine a position of the UE in response to reception of a positioning request.

12. The apparatus of claim 11, wherein:
the processor further configures the apparatus to send the data to train a ML model to the NWDAF containing the MTLF to provide the trained ML model, and
the data comprises location information and measurements collected by the LMF from the UE and next generation radio access network (NG-RAN) nodes.

13. The apparatus of claim 11, wherein:
performance metrics of the trained ML model are monitored by the NWDAF containing the MTLF; and
receive, from the NWDAF containing the MTLF, an updated trained ML model that is retrained based on the monitored performance metrics.

14. The apparatus of claim 11, wherein the processor further configures the apparatus to send, to the NWDAF containing the MTLF, location data collected from at least one of the UE or a next generation radio access network (NG-RAN) node.

15. The apparatus of claim 11, wherein the processor further configures the apparatus to send the ML model training subscription request in response to a determination to use the trained ML model to perform a location calculation of the UE.

16. The apparatus of claim 11, wherein the processor further configures the apparatus to:
monitor performance metrics of the trained ML model; and
initiate retraining of the trained ML model based on the monitored performance metrics.

17. The apparatus of claim 11, wherein the positioning measurements comprise:
location information from the UE collected using long term evolution (LTE) Positioning Protocol (LPP) messages, and
location information from next generation radio access network (NG-RAN) nodes collected using new radio (NR) Positioning Protocol a (NRPPa).

18. The apparatus of claim 11, wherein the processor further configures the apparatus to determine which of the trained ML model or legacy positioning is to be used for UE positioning.

19. A non-transitory computer-readable storage medium that stores instructions for execution by one or more processors of an apparatus of a Network Data Analytics Function (NWDAF) containing a Model Training Logical Function (MTLF), the instructions, when executed, configured to cause the apparatus to:
receive, from a Location Management Function (LMF), a machine learning (ML) model training subscription request for a trained ML model for user equipment (UE) positioning;
train a ML model for UE positioning analytics using data of a UE; and
after training the ML model, transmit the ML model to the LMF to determine a position of the UE.

20. The non-transitory computer-readable storage medium of claim 19, wherein:
the instructions, when executed, configure the apparatus to receive the data for training the ML model from the LMF, and
the data comprises location information and measurements collected by the LMF from the UE and a next generation radio access network (NG-RAN) node.
